(19) United States
(12) Patent Application Publication
(10) Pub. No.: US 2014/0058875 A1
(43) Pub. Date: Feb. 27, 2014

(54) METHODS FOR FACILITATING AN ELECTRONIC SIGNATURE AND DEVICES THEREOF

(71) Applicant: Gregory Karl Yanchenko, Groton, MA (US)

(72) Inventor: Gregory Karl Yanchenko, Groton, MA (US)

(73) Assignee: BIDDOCS ONLINE, INC., Groton, MA (US)

(21) Appl. No.: 13/590,425

(22) Filed: Aug. 21, 2012

(51) Int. Cl. H04L 9/32; G06Q 30/08

(52) U.S. Cl. 705/26.3; 726/7

(57) ABSTRACT

A method, non-transitory computer readable medium, and an electronic signature registration server that obtains a request from a user to register for access to a Web site, wherein the request includes login credentials. The login credentials are associated with a first access level such that the user is provided access to a first portion of the Web site. A signature authorization form is generated including a graphical representation of a unique identifier associated with the user. The signature authorization form is provided to the user. Upon receiving a fully executed version of the signature authorization form from the user, the login credentials are associated with a second access level such that the user is provided access to a second portion of the Web site.

### FIELD

This technology generally relates to electronic signatures and, more particularly, to facilitating secure access to a Web site, such as an electronic bidding platform, and authenticating content submitted to the host of the Web site based on the electronic signatures.

### BACKGROUND

Content providers, such as Web site hosts, are often required to establish portions of a Web site as secure and accessible only by authorized users. Additionally, some Web sites that obtain content from users are required to restrict submission of electronic documents, for example, to authorized users based on an electronic signature verifying the authenticity of the documents.

One exemplary Web site is an electronic bidding platform including a plurality of Web pages. A host of an electronic bidding platform may want to restrict access to the portions of the Web site that allow for submission of bids to authorized bidders. However, merely restricting Web page access may not provide sufficient safeguards with respect to the validity and/or authenticity of the documents or other content associated with a submitted bid.

For example, a host of a bidding platform may be an intermediary accepting bid submissions on behalf of third parties, such as entities soliciting for public and private construction bid projects. The third parties may have authenticity requirements for bids submitted in paper form (e.g. signature, notarization, and/or affixing of a seal) providing a level of security that must be matched or exceeded in a corresponding electronic bidding process.

### SUMMARY

A method for facilitating an electronic signature includes obtaining, at an electronic signature registration server, a request from a user of a client computing device to register for access to a Web site comprising a plurality of Web pages, wherein the request includes login credentials. The login credentials are associated, with the electronic signature registration server, with a first access level such that the user of the client computing device is provided access to a first subset of the plurality of Web pages. A signature authorization form including a graphical representation of a unique identifier associated with the user of the client computing device is generated with the electronic signature registration server. The signature authorization form is provided, with the electronic signature registration server, to the client computing device. Upon receiving a fully executed version of the signature authorization form from the user of the client computing device, the login credentials are associated, with the electronic signature registration server, with a second access level such that the user of the client computing device is provided access to a second subset of the plurality of Web pages including Web pages not included in the first subset of the plurality of Web pages.

A non-transitory computer readable medium having stored thereon instructions comprising machine executable code which when executed by a processor, causes the processor to perform steps including obtaining a request from a user of a client computing device to register for access to a Web site comprising a plurality of Web pages, wherein the request includes login credentials. The login credentials are associated with a first access level such that the user of the client computing device is provided access to a first subset of the plurality of Web pages. A signature authorization form including a graphical representation of a unique identifier associated with the user of the client computing device is generated. The signature authorization form is provided to the client computing device. Upon receiving a fully executed version of the signature authorization form from the user of the client computing device, the login credentials are associated with a second access level such that the user of the client computing device is provided access to a second subset of the plurality of Web pages including Web pages not included in the first subset of the plurality of

An electronic signature registration server includes a processor coupled to a memory and configured to execute programmed instructions stored in the memory including obtaining a request from a user of a client computing device to register for access to a Web site comprising a plurality of Web pages, wherein the request includes login credentials. The login credentials are associated with a first access level such that the user of the client computing device is provided access to a first subset of the plurality of Web pages. A signature authorization form including a graphical representation of a unique identifier associated with the user of the client computing device is generated. The signature authorization form is provided to the client computing device. Upon receiving a fully executed version of the signature authorization form from the user of the client computing device, the login credentials are associated with a second access level such that the user of the client computing device is provided access to a second subset of the plurality of Web pages including Web pages not included in the first subset of the plurality of Web pages.

This technology provides a number of advantages including methods, non-transitory computer readable medium, and an electronic signature registration server that provides secure access to a Web site, such as an electronic bidding platform, and improved reliability with respect to the authenticity of content submitted to the Web site, such as part of an electronic bid.

### BRIEF DESCRIPTION OF THE DRAWINGS

FIG. 1 is a block diagram of an exemplary network environment which incorporates client computing devices coupled to an exemplary electronic signature registration server;

FIG. 2 is a flowchart of an exemplary method for facilitating an electronic signature for content submitted as part of an electronic bid;

FIG. 3 is an exemplary registration Web page for obtaining information for users of an electronic bidding platform;

FIG. 4 is an exemplary signature authorization form;

FIG. 5 is a an exemplary login Web page for facilitating the verification of credentials for users of the electronic bidding platform;

FIG. 6 is an exemplary account authorization Web page providing additional instructions and a link to the exemplary signature authorization form for users having limited access to the electronic bidding platform; and

FIG. 7 is an exemplary form Web page presented to users having limited access to the electronic bidding platform.

### DETAILED DESCRIPTION

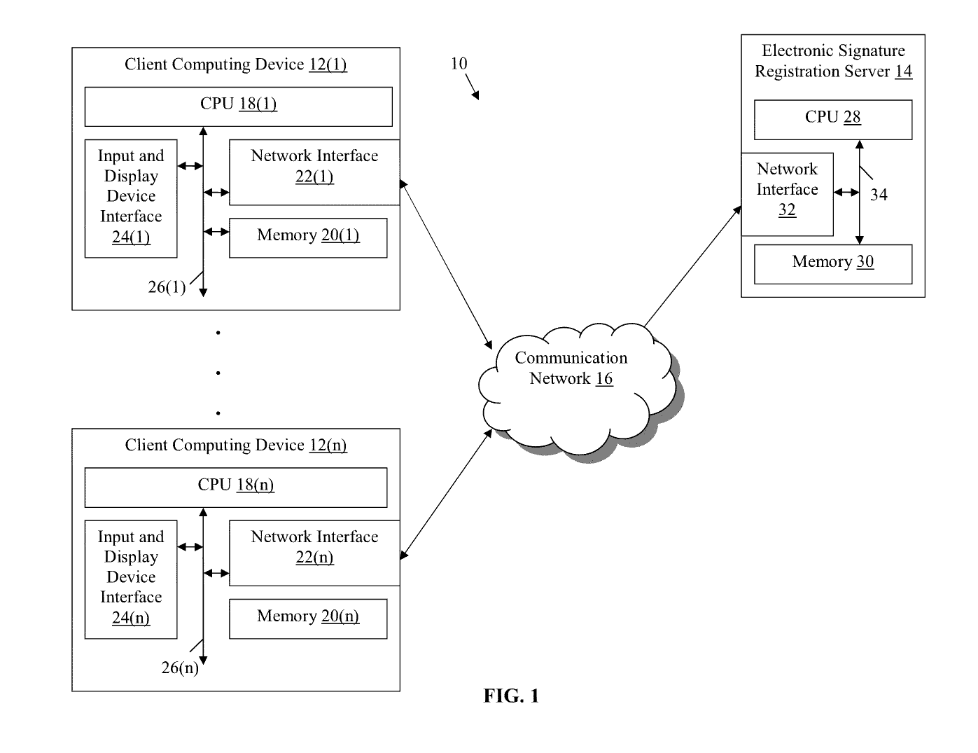

An exemplary environment 10 with client computing devices 12(1)-12(n) coupled to an electronic signature registration server 14 by a communication network 16 is illustrated in FIG. 1, although this environment 10 can include other numbers and types of systems, devices, components, and elements in other configurations, such as multiple numbers of electronic signature registration servers 14 and communication networks 16. While not shown, the environment 10 also may include additional network components, such as routers, switches and other devices, which are well known to those of ordinary skill in the art and thus will not be described here. This technology provides a number of advantages including methods, non-transitory computer readable medium, and an electronic signature registration server that facilitate an electronic signature for documents submitted electronically to a Web site. While the exemplary Web site described herein is an electronic bidding platform for receiving electronic bid documents, the methods and devices of the invention can be used in combination with any Web site providing any service requiring secure access and authentication of electronically submitted documents.

The client computing devices 12(1)-12(n) each include a central processing unit (CPU) 18(1)-18(n) including one or more processors, a memory 20(1)-20(n), a network interface 22(1)-22(n), and an input and display device interface 24(1)-24(n), which are coupled together by a bus 26(1)-26(n) or other link, although other numbers and types of systems, devices, components, and elements in other configurations and locations can be used.

The CPU 18(1)-18(n) in each of the client computing devices 12(1)-12(n) executes a program of stored instructions for one or more aspects of the present technology as described and illustrated by way of the examples herein, although other types and numbers of processing devices and configurable hardware logic could be used and the processor could execute other numbers and types of programmed instructions.

The memory 20(1)-20(n) in each of the client computing devices 12(1)-12(n) stores these programmed instructions for one or more aspects of the present technology, as described and illustrated herein, although some or all of the programmed instructions could be stored and/or executed elsewhere. The memory 20(1)-20(n) in the client computing devices 12(1)-12(n) optionally stores programmed instructions for a Web browser for communicating with the network interface 22(1)-22(n) to operatively exchange content with the electronic signature registration server 14. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the CPU 18(1)-18(n), can be used for the memory 20(1)-20(n).

The network interface 22(1)-22(n) in each of the client computing devices 12(1)-12(n) is used to operatively couple and communicate between the client computing device 12(1)-12(n) and the electronic signature registration server 14 via the communications network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The input and display device interface 24(1)-24(n) in each of the client computing devices 12(1)-12(n) is used to enable a user to interact with the client computing devices 12(1)-12(n), such as to input and/or view data and/or to configure, program and/or operate the client computing devices 12(1)-12(n) by way of example only. Input devices may include a keyboard, computer mouse, and/or touchscreen and display devices may include a computer monitor, although other types and numbers of input devices and display devices could be used.

The electronic signature registration server 14 includes a central processing unit (CPU) 28 including one or more processors, a memory 30, and a network interface 32, which are coupled together by a bus 34 or other link, although other numbers and types of systems, devices, components, and elements in other configurations and locations can be used. The CPU 28 in the electronic signature registration server 14 executes a program of stored instructions for one or more aspects of the present technology as described and illustrated by way of the examples herein, although other types and numbers of processing devices and configurable hardware logic could be used and the CPU 28 could execute other numbers and types of programmed instructions.

The memory 30 in the electronic signature registration server 14 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the CPU 28, can be used for the memory 30.

The network interface 32 in the electronic signature registration server 14 is used to operatively couple and communicate between the electronic signature registration server 14 and the client computing devices 12(1)-12(n) via the communications network 16, although other types and numbers of communication networks or systems with other types and numbers of connections and configurations can be used.

Although examples of the electronic signature registration server 14 and the client computing devices 12(1)-12(n) which are coupled together via the communication network 16 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

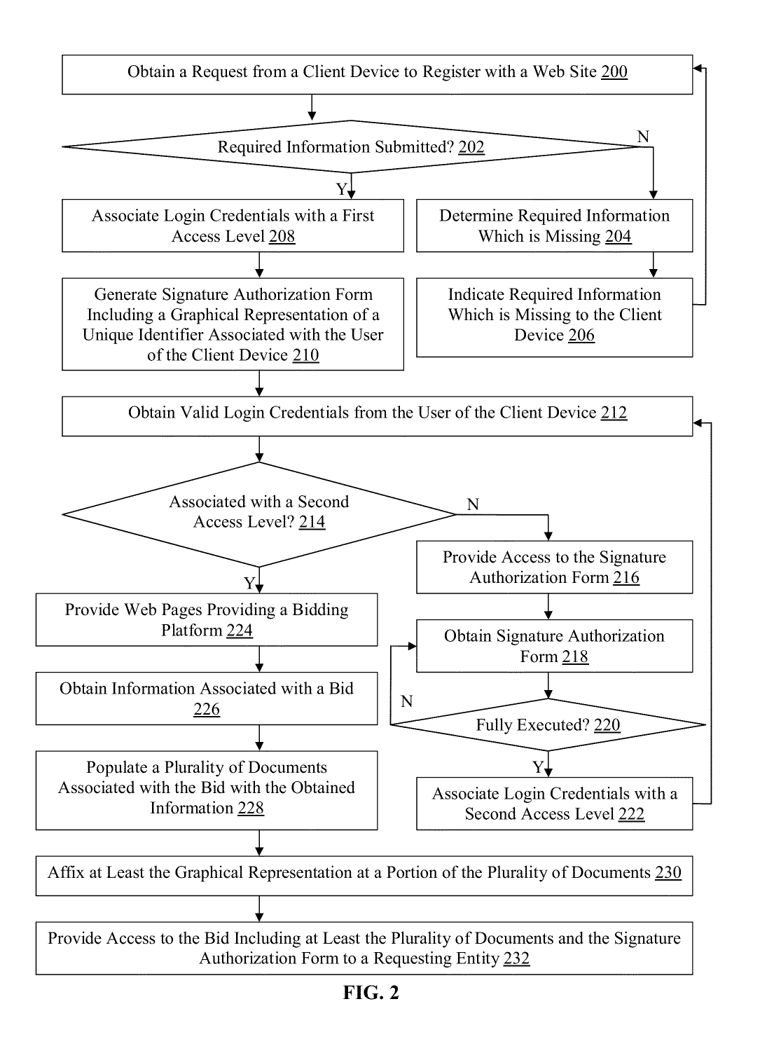

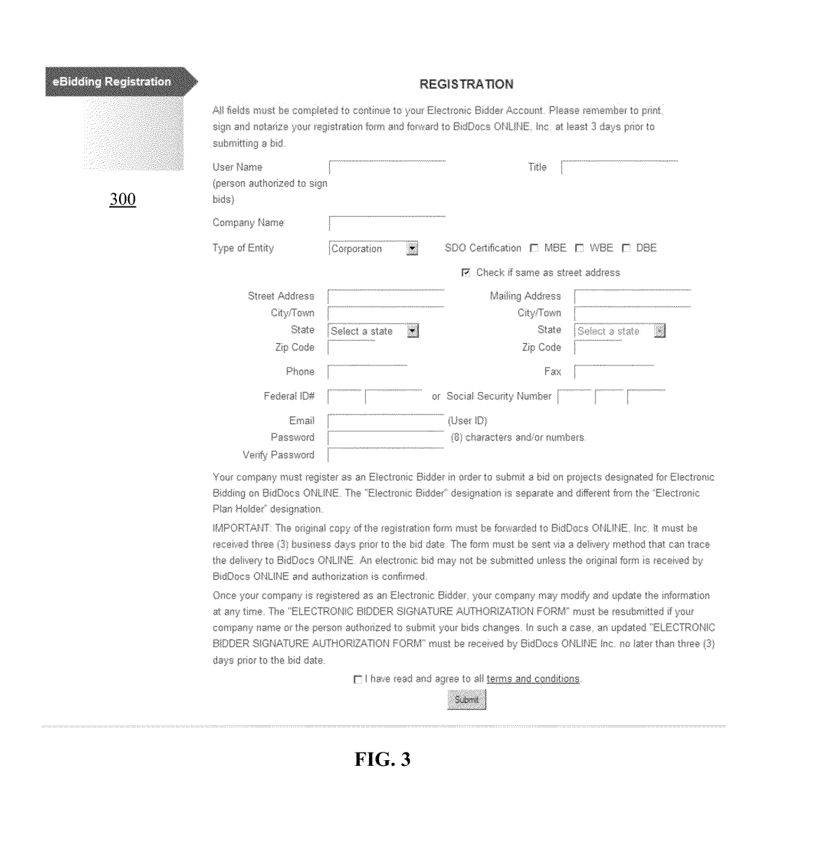

Exemplary methods and devices for facilitating an electronic signature will now be described with reference to FIGS. 1-7. Referring specifically to FIG. 2, in step 200, the electronic signature registration server 14 obtains a request from a user of one of the client computing devices 12(1) to register for access to a Web site including a plurality of Web pages. One exemplary registration Web page 300 of the Web site that is configured to receive the registration information is shown in FIG. 3.

The registration request submitted by the user of the client computing device 12(1) includes at least login credentials and a unique identifier. The login credentials can include a user name and a password, for example, and the unique identifier can include a federal identification number or a social security number, for example, although other credentials and/or identifiers can also be used. Optionally, the registration Web page 300 is further configured to receive biographical information associated with the user including street and mailing address and entity type, for example, although other information can also be received.

In step 202, the electronic signature registration server 14 determines whether all of the required information has been submitted by the user of the client computing device 12(1) and/or whether the submitted information is valid. Accordingly, in this example, the registration Web page 300 can be configured such that the information submitted by a user of one of the client computing device 12(1)-12(n) is only received and stored by the electronic signature registration server 14 when a specified subset (e.g. the login credentials and the unique identifier) or all of the fields contain data. The required fields can be indicated using the form validation feature of hypertext markup language (HTML) 5, for example, although other methods of establishing certain fields as required can be used. Additionally, the electronic signature registration server 14 can process the received request to determine whether the user name and/or unique identifier, for example, are valid or have already been associated with another user, for example.

By establishing required fields in the registration Web page 300, the user can be required to submit a subset or all of the data indicated by the fields of the registration Web page 300 such that the required data can be used as described and illustrated later. If the electronic signature registration server 14 determines all of the required information has not been submitted or at least a portion of the submitted information is not valid, then the No branch is taken and the electronic signature registration server 14 proceeds to step 204.

In step 204, the electronic signature registration server 14 identifies the required fields for which the user of the client computing device 12(1) did not submit data or did not submit valid data. In step 206, the electronic signature registration server 14 indicates to the user which required fields have not been completed effectively, such as by causing the registration Web page 300 to refresh with an indication next to one or more of the deficient fields. In some examples, the registration Web page 300 cannot be submitted until all of the required fields are completed, such as when the registration Web page 300 incorporates the form validation feature of HTML 5. In these examples, steps 204 and 206 can be omitted or limited to validating the submitted information.

Upon refreshing the registration Web page, the electronic signature registration server 14 can obtain a subsequent request from the user of the client computing devices 12(1). If the electronic signature registration server 14 determines, at step 202, that all of the required information has been submitted and/or all of the information is valid, then the Yes branch is taken and the electronic signature registration server 14 proceeds to step 208.

In step 208, the electronic signature registration server 14 associates the login credentials obtained in step 200 with a first access level, such as in a database in the memory 30. Additionally, the electronic signature registration server 14 can store some or all of the submitted information as associated with the login credentials. By associating the login credentials with a first access level, the user of the client computing device 12(1) is effectively provided access to a first subset of the plurality of Web pages, as described and illustrated later.

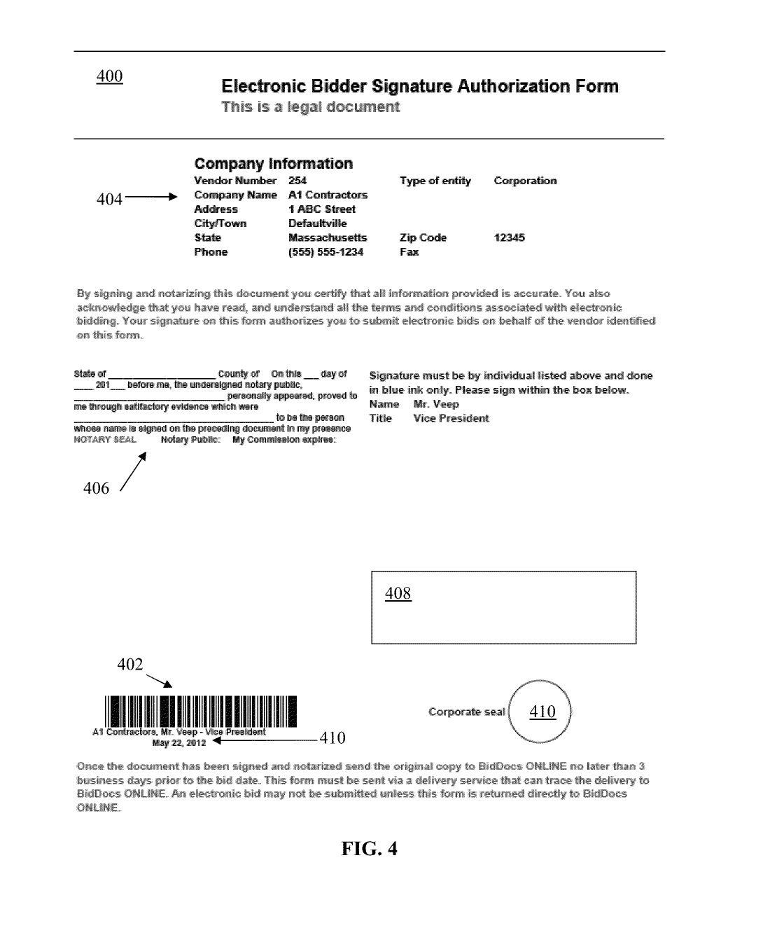

In step 210, the electronic signature registration server 14 generates a signature authorization form, such as the exemplary signature authorization form 400 shown in FIG. 4, and stores the generated signature authorization form 400 in the memory 30. In this example, the signature authorization form includes a graphical representation 402 of a unique identifier associated with the user of the client computing device 12(1). The unique identifier can be the unique identifier obtained in step 200 and stored in the memory 30 as associated with the user. In other examples, the graphical representation 402 is unique to the user but not based on the unique identifier obtained in step 200. The graphical representation 402 can be a two or three dimensional bar code, for example, although any unique graphical representation 402 can be used irrespective of whether the graphical representation 402 encodes unique information.

In this example, the signature authorization form 400 is also populated with at least a portion of the biographical information 404 obtained in step 200 and stored in the memory 30. Additionally, the signature authorization form 400 includes spaces for a notarization 406, a signature 408, and/or a corporate seal 410, although the signature authorization form 400 can include other information and spaces. The signature authorization form 400 can also include a date 412 optionally disposed proximate the graphical representation 402 along with identification information such as the user's name and/or associated entity. The date 410 can be the date the form was generated, for example, although other dates can also be used.

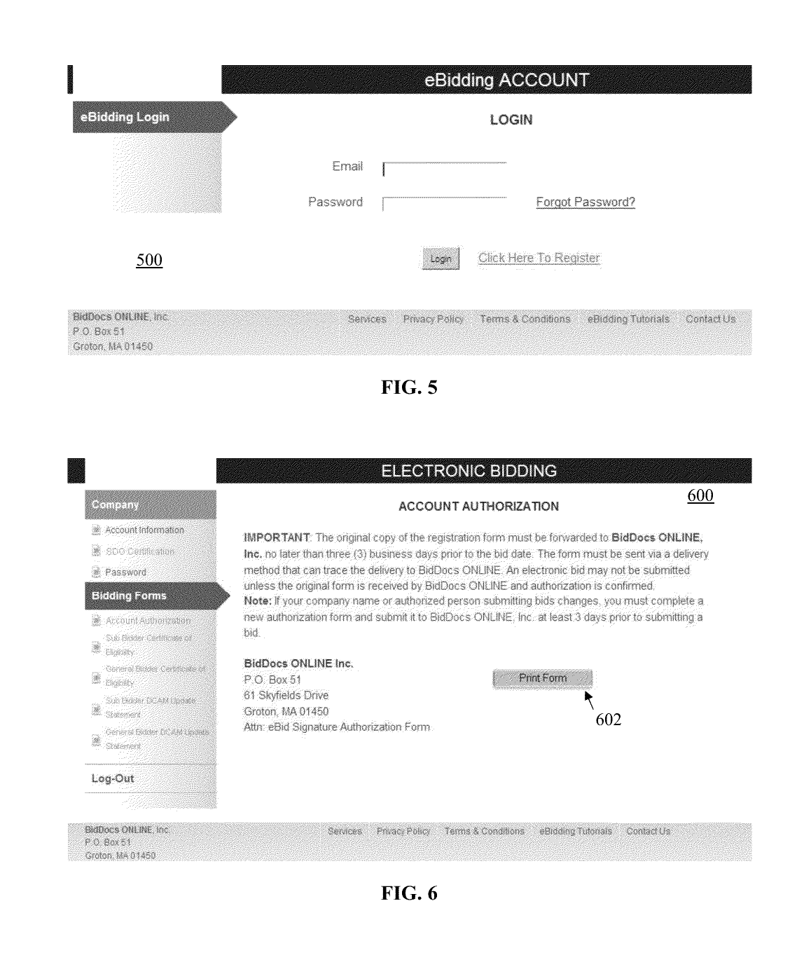

Optionally, upon validation of the login credentials, the electronic signature registration server 14 can notify the user that at least partial access to the Web site is available. The notification can be an automated e-mail sent to an e-mail address obtained in step 200, although other methods of notification can be used. Additionally, a link can be provided in the notification e-mail to a login Web page of the Web site, such as the login Web page 500 shown in FIG. 5.

Irrespective of whether the user follows a provided link or returns to the Web site, in step 212, the electronic signature registration server 14 sends the login Web page 500 to the client computing device 12(1) and obtains login credentials from the user of the client computing device 12(1). Upon obtaining the login credentials, the electronic signature registration server 14 validates the credentials based on the information stored in the memory 30 during the registration process. When the login credentials have been validated, the electronic signature registration server 14 proceeds to step 214.

In step 214, the electronic signature registration server 14 determines whether the login credentials obtained in step 212 are associated with a second access level. The first time a user of the client computing device 12(1) submits login credentials, this condition will not be satisfied and the No branch will be taken by the electronic signature registration server 14 which will proceed to step 216.

In step 216, the electronic signature registration server 14 provides the user access to the signature authorization form 400. Accordingly, the first subset of the Web pages of the Web site includes at least one Web page that provides the user of the client computing device 12(1) access to the signature authorization form 400 generated in step 210. The first subset of Web pages are those pages accessible according to the first access level associated with the user's login credentials in step 208. One such exemplary Web page is the account authorization Web page 600 shown in FIG. 6. The account authorization Web page 600 provides additional instructions and a link 602 to the exemplary signature authorization form 400 for users having limited access to the electronic bidding platform.

In step 218, the host of the electronic signature registration server 14 obtains an at least partially executed signature authorization form from the user of the client computing devices 12(1). Optionally, the executed signature authorization form is obtained through a regular mail process so that the host can physically store the physical, tangible, or “wet” executed signature authorization form.

In step 220, the host of the electronic signature registration server 14 determines whether the obtained signature authorization form is fully executed. Referring to the exemplary signature authorization form 400, the host of the electronic signature registration server 14 can identify and/or validate one or more of a notarized signature of an authorized representative of the entity associated with the user and/or an affixed corporate seal.

If the host of the electronic signature registration server 14 determines that the obtained authorization form is not fully executed, then the No branch is taken to step 218 in which a new signature authorization form is obtained. Optionally, the user can be notified by phone or e-mail, for example, of the submission of a deficient signature authorization form thereby prompting submission of a subsequent executed form in step 218. If the host of the electronic signature registration server 14 determines that the obtained authorization form is fully executed, then the Yes branch is taken to step 222.

In step 222, the electronic signature registration server 14 associates the user's login credentials with a second access level, such as in the database in the memory 30. By associating the login credentials with a second access level, the user of the client computing device 12(1) is effectively provided access to a second subset of the plurality of Web pages of the Web site, which may be include all of the other pages of the Web site not included in the first subset of Web pages, for example. Optionally, the user can be notified, such as by e-mail, that the user's executed signature authorization form was fully executed and accepted and that the user has been provided additional access privileges with respect to the electronic bidding platform Web site.

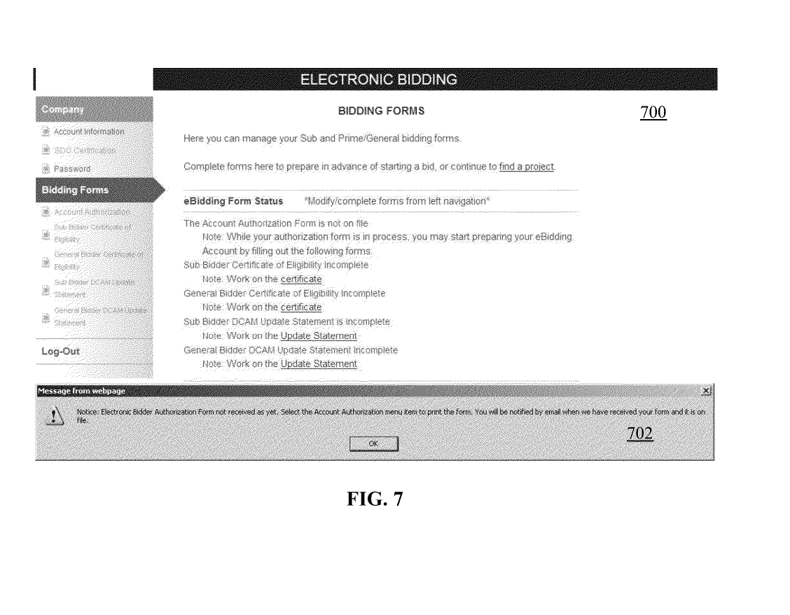

Prior to step 222, in one example, the user having limited access to only the first subset of Web page may attempt to access Web pages associated with the second access level. One exemplary Web page can be the forms Web page 700 shown in FIG. 7 which provides access to electronic documents that can be executed and submitted to the electronic signature registration server 14 as part of an electronic bid. Optionally, a notification can be displayed, such as the notification 702, indicating that the user has not yet submitted a signature authorization form, or a submitted form has not yet been accepted by the host of the electronic signature registration server 14. Other notifications and other methods of restricting access can also be used.

In this example, upon subsequently obtaining login credentials from the user of the client computing device 12(1) in step 212, as described and illustrated earlier, the electronic signature registration server 14 proceeds to step 214. As, in this example, the user's login credentials have been associated with the second access level in step 222, the condition in step 214 will be satisfied, and the Yes branch will be taken to step 224. While this example assumes that the user logs out of the Web site and logs back in at step 212, in other examples, the user can be provided access to the second subset of Web pages without logging out and in response to the association of the user's login credentials with the second access level by the electronic signature authorization server 14 in step 222.

In step 224, the electronic signature registration server 14 provides one or more Web pages included in the second plurality of Web pages to the user of the client computing device 12(1) in response to a request for the one or more Web pages. While the Web site in this example is an electronic bidding platform and the plurality of the Web pages are configured to provide services and content for facilitating submission of a bid by a user of one of the client computing devices 12(1)-12(n), the methods and devices described herein can be used in combination with any other Web site. Accordingly, the Web pages providing a bidding platform provided to the client computing device 12(1) in step 224 can be any Web pages configured to facilitate receipt of electronic documents or other content requiring authentication and/or an electronic signature.

In this example, in step 226, the electronic signature registration server 14 obtains information associated with a bid including the bid value, any subcontractors to be used, and/or the services to be performed, for example. The information can be submitted using a plurality of fields on one or more of the second subset of Web pages, for example. Optionally, the submitted information can be stored by the electronic signature registration server 14 in the memory 30.

In step 228, the electronic signature registration server 14 populates a plurality of documents associated with the bid with the obtained information. In one example, the bidding platform is used by general contractors and subcontractors to submit bids in response to solicitations from government entities. In this example, the government entities may have a plurality of forms and other documents that must be executed to form a complete bid. Accordingly, to facilitate submission of the bids for users of the electronic signature registration server 14, the plurality of required documents can be populated based on the information obtained in step 226.

In step 230, the electronic signature registration server 14 affixes at least the graphical representation included on the signature authorization form generated in step 210 to each of the plurality of documents populated in step 228. Optionally, the graphical representation is affixed to each of the plurality of documents at a corresponding portion to mitigate any unauthorized reproduction of the documents that might occur. Also optionally, a date stamp can be affixed at a corresponding portion of each of the plurality of documents. The date stamp can represent the date the information associated with the bid was received from the user of the client computing device 12(1) at step 226, for example. The plurality of documents, together with the executed signature authorization form forming a complete submitted bid, can be stored by the electronic signature registration server 14 in the memory 30.

In step 232, the electronic signature registration server 14 optionally provides access to the bid submitted by the user of the client computing device 12(1) to a requesting entity. The bid can include at least the plurality of documents as well as the signature authorization form. The requesting entity can be the third party sponsor or solicitor of the bids, such as a government entity in the example described and illustrated herein. The access to the bid submitted by the user can be based on a separate login by the requesting entity that is associated with a third access level providing access to the bids stored by the electronic signature registration server 14 in the memory 30, although other methods of providing access to requesting entities can be used. Steps 212, 214, and 224-232 can be repeated to facilitate the user's submission of subsequent bids. In the subsequent bids, the same executed signature authorization form stored in the memory 30 can be included in the bid with the plurality of documents forming the bid. Additionally, users of other client computing devices 12(2)-12(n) can register with the Web site, log into the Web site, submit bids, or perform any of the steps 200-232 concurrently with any other user.

By this technology, the protections and level of security provided by authentication measures in a paper submission process such as notarization, signature, and affixing of a corporate seal, for example, can be afforded to submission of electronic documents, such as documents forming an electronic bid. With this technology, users of a Web site are only provided access to a portion of the Web site configured to receive electronic documents requiring authentication when the users have previously submitted a physical, fully executed signature authorization form satisfying traditional authentication standards. When electronic documents are submitted to the host of the Web site, the signature authorization form is included providing an increased level of security and authentication for the electronically submitted documents. Thereby, authentication concerns of third parties that may be the final recipients of the electronic documents can be mitigated.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating an electronic signature, comprising:
obtaining, at an electronic signature registration server, a request from a user of a client computing device to register for access to a Web site comprising a plurality of Web pages, wherein the request includes login credentials;
associating, with the electronic signature registration server, the login credentials with a first access level such that the user of the client computing device is provided access to a first subset of the plurality of Web pages;
generating, with the electronic signature registration server, a signature authorization form including a graphical representation of a unique identifier associated with the user of the client computing device;
providing, with the electronic signature registration server, the signature authorization form to the client computing device; and
associating, with the electronic signature registration server, upon receiving a fully executed version of the signature authorization form from the user of the client computing device, the login credentials with a second access level such that the user of the client computing device is provided access to a second subset of the plurality of Web pages including Web pages not included in the first subset of the plurality of Web pages.

2. The method of claim 1, wherein the unique identifier is based on information included in the request selected from a social security number or a federal identification number and wherein the graphical representation is a barcode.

3. The method of claim 1, further comprising determining with the electronic signature registration server whether the obtained signature authorization form is fully executed comprising determining whether the obtained signature authorization form includes a notarized signature of an authorized representative and an affixed corporate seal.

4. The method of claim 1, wherein the Web site is a bidding platform and the plurality of the Web pages are configured to provide services and content for facilitating submission of a bid by a user of the client computing device, the method further comprising
receiving, with the electronic signature registration server, information associated with a bid from the user of the client computing device;
populating, with the electronic signature registration server, a plurality of documents associated with the bid with the received information; and
affixing, with the electronic signature registration server, the graphical representation at a corresponding portion of each of the plurality of documents.

5. The method of claim 4, further comprising affixing, with the electronic signature registration server, a date stamp at a corresponding portion of each of the plurality of documents wherein the date stamp is associated with at least a date at which the information associated with the bid was received from the user of the client computing device.

6. The method of claim 5, further comprising providing, with the electronic signature registration server, access to a requesting entity to at least the plurality of documents and the signature authorization form.

7. The method of claim 1, wherein the first subset of the Web pages includes a Web page configured to provide the user of the client computing device with access to the signature authorization form.

8. A non-transitory computer readable medium having stored thereon instructions for facilitating an electronic signature comprising machine executable code which when executed by a processor, causes the processor to perform steps comprising:
obtaining a request from a user of a client computing device to register for access to a Web site comprising a plurality of Web pages, wherein the request includes login credentials;
associating the login credentials with a first access level such that the user of the client computing device is provided access to a first subset of the plurality of Web pages;
generating a signature authorization form including a graphical representation of a unique identifier associated with the user of the client computing device;
providing the signature authorization form to the client computing device; and
associating, upon receiving a fully executed version of the signature authorization form from the user of the client computing device, the login credentials with a second access level such that the user of the client computing device is provided access to a second subset of the plurality of Web pages including Web pages not included in the first subset of the plurality of Web pages.

9. The medium of claim 8, wherein the unique identifier is based on information included in the request selected from a social security number or a federal identification number and wherein the graphical representation is a barcode.

10. The medium of claim 8, further having stored thereon instructions that when executed by the processor cause the processor to perform steps further comprising determining whether the obtained signature authorization form is fully executed comprising determining whether the obtained signature authorization form includes a notarized signature of an authorized representative and an affixed corporate seal.

11. The medium of claim 8, wherein the Web site is a bidding platform and the plurality of the Web pages are configured to provide services and content for facilitating submission of a bid by a user of the client computing device, the medium further having stored thereon instructions that when executed by the processor cause the processor to perform steps further comprising:
receiving information associated with a bid from the user of the client computing device;
populating a plurality of documents associated with the bid with the received information; and
affixing the graphical representation at a corresponding portion of each of the plurality of documents.

12. The medium of claim 11, further having stored thereon instructions that when executed by the processor cause the processor to perform steps further comprising affixing a date stamp at a corresponding portion of each of the plurality of documents wherein the date stamp is associated with at least a date at which the information associated with the bid was received from the user of the client computing device.

13. The medium of claim 12, further having stored thereon instructions that when executed by the processor cause the processor to perform steps further comprising further comprising providing access to a requesting entity to at least the plurality of documents and the signature authorization form.

14. The medium of claim 8, wherein the first subset of the Web pages includes a Web page configured to provide the user of the client computing device with access to the signature authorization form.

15. An electronic signature registration server apparatus, comprising:
a processor coupled to a memory and configured to execute programmed instructions stored in the memory comprising:
obtaining a request from a user of a client computing device to register for access to a Web site comprising a plurality of Web pages, wherein the request includes login credentials;
associating the login credentials with a first access level such that the user of the client computing device is provided access to a first subset of the plurality of Web pages;
generating a signature authorization form including a graphical representation of a unique identifier associated with the user of the client computing device;
providing the signature authorization form to the client computing device; and
associating, upon receiving a fully executed version of the signature authorization form from the user of the client computing device, the login credentials with a second access level such that the user of the client computing device is provided access to a second subset of the plurality of Web pages including Web pages not included in the first subset of the plurality of Web pages.

16. The apparatus of claim 15, wherein the unique identifier is based on information included in the request selected from a social security number or a federal identification number and wherein the graphical representation is a barcode.

17. The apparatus of claim 15, wherein the processor is further configured to execute programmed instructions stored in the memory further comprising determining whether the obtained signature authorization form is fully executed comprising determining whether the obtained signature authorization form includes a notarized signature of an authorized representative and an affixed corporate seal.

18. The apparatus of claim 15, wherein the Web site is a bidding platform and the plurality of the Web pages are configured to provide services and content for facilitating submission of a bid by a user of the client computing device and the processor is further configured to execute programmed instructions stored in the memory further comprising:
receiving information associated with a bid from the user of the client computing device;
populating a plurality of documents associated with the bid with the received information; and
affixing the graphical representation at a corresponding portion of each of the plurality of documents.

19. The apparatus of claim 18, wherein the processor is further configured to execute programmed instructions stored in the memory further comprising affixing a date stamp at a corresponding portion of each of the plurality of documents wherein the date stamp is associated with at least a date at which the information associated with the bid was received from the user of the client computing device.

20. The apparatus of claim 19, wherein the processor is further configured to execute programmed instructions stored in the memory further comprising providing access to a requesting entity to at least the plurality of documents and the signature authorization form.

21. The apparatus of claim 15, wherein the first subset of the Web pages includes a Web page configured to provide the user of the client computing device with access to the signature authorization form.
